(19) United States
(12) Patent Application Publication
(10) Pub. No.: US 2007/0241880 A1
(43) Pub. Date: Oct. 18, 2007

(54) Alerting device, transporting device, transporting method, and exposure apparatus

(75) Inventor: Junichi Ishihara, Kumagaya-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 11/253,723

(22) Filed: Oct. 20, 2005

Related U.S. Application Data
(63) Continuation of application No. PCT/JP04/05789, filed on Apr. 22, 2004.

(30) Foreign Application Priority Data
Apr. 25, 2003 (JP) 2003-121790

(51) Int. Cl. G08B 19/00

(52) U.S. Cl. 340/521

(57) ABSTRACT

An alerting device has: a shock sensor, mounted to or in the vicinity of a main body of an exposure apparatus being transported, which detects values with respect to shocks acting on the device; a controlling device which determines whether or not values detected by the shock sensor have exceeded predetermined tolerable values; and an alerting lamp which emits alerts based on the determination results made by the controlling device. By doing this, it is possible to provide an alerting device which provides alerts with respect to transportation environment and transportation conditions of precision apparatuses, e.g., exposure apparatuses during the transportation thereof on a real-time basis.

### CROSS-REFERENCE TO RELATED APPLICATION

This is a Continuation Application of International Application No. PCT/JP2004/005789, filed Apr. 22, 2004, which claims priority to Japanese Patent Application No. 2003-121790, filed Apr. 25, 2003. The contents of the aforementioned applications are entirely incorporated herein by reference.

### BACKGROUND OF THE INVENTION

1. Field of the Invention

The present invention relates to an alerting device, transporting device transporting method, and an exposure apparatus.

2. Description of Related Art

An exposure apparatus which is used in photo-lithographic steps is packed by packaging material, and trucks and aircrafts are used for transporting the exposure apparatus from a manufacturer of the exposure apparatus to a semiconductor manufacturer (see Japanese Unexamined Patent Application, First Publication No. 2000-203678). During such transportations, there is a concern that shocks generated in the transportation may affect the exposure apparatus. Various attempts have been made in order to determine whether or not shocks which exceed predetermined values have acted on the exposure apparatus and to notice where the shocks have affected the exposure apparatus, e.g., mounting shock sensors onto the exposure apparatus being transported, accumulating data with respect to shocks generated during the transportation in a built-in memory section in the shock sensors, detaching the shock sensors from the exposure apparatus after transportation, extracting and analyzing the accumulated in the memory section.

However, in the related technique, the data with respect to the shocks accumulated in the memory section are analyzed after completing transportation; therefore, the transporter cannot notice the fact that the exposure apparatus has been affected by the shocks on a real-time basis. There has been a problem in that appropriate remedies have not been developed.

### SUMMARY OF THE INVENTION

The present invention was conceived in view of the above circumstances, and an object thereof is to provide an alerting device which emits alerts with respect to transportation conditions and transportation environment of precision apparatuses, e.g., exposure apparatuses, on a real-time base. Another object thereof is to provide a transporting device and transporting method using the alerting device. Yet another object thereof is to provide an exposure apparatus which is transported along with the alerting device.

In order to overcome the above problem, the present invention employs the following features corresponding to embodiments shown in FIGS. 1 to 11.

An alerting device of the present invention is characterized in including: detecting devices, mounted to or in the vicinity of a precision apparatus being transported, which detect at least any one of transportation conditions and transportation environment of the precision apparatus; a determining device which determines whether or not values detected by the detecting devices have exceeded predetermined values; and informing devices which emit alerts based on the determination results made by the determining device.

A transporting device of the present invention is characterized in that the transporting device transports the precision apparatus, and the transporting device includes the alerting device.

A transporting method of the present invention is characterized in that the transporting method is used for transporting the precision apparatus, and the precision apparatus is transported with the above alerting device.

An exposure apparatus of the present invention is characterized in being transported by the above method.

According to the present invention, the detecting devices are mounted to or in the vicinity of the precision apparatus which is being transported, and the detecting devices detect at least any one of transportation conditions and transportation environment of the precision apparatus. Whether or not the values detected by the detecting devices exceed predetermined values is determined, and alerts based on the determination results are emitted in accordance with the determination results. Therefore, it is possible to know the transportation conditions and the transportation environment of the precision apparatus being transported on a real-time base. Therefore, even if shocks having levels exceeding the predetermined values act on the precision apparatus, the transporter can apply appropriate remedies promptly; thus, it is possible to minimize adverse effects on the precision apparatuses. The above transportation conditions include properties, e.g., shocks (accelerations) acting on the precision apparatus, and attitudes of the precision apparatus being transported. The above transportation environment indicates an environment, to which the precision apparatus being transported is subjected, including properties e.g., temperature, humidities, and densities of predetermined substances, e.g., oxygen. In addition to shock sensors which detect shocks acting on the precision apparatus, the above detecting device includes sensors, e.g., temperature sensors which detect temperatures, humidity sensors which detect humidities, density sensors which detect densities of the predetermined substance, e.g., oxygen, and attitude sensors which detect attitudes of the precision apparatus being transported.

### BRIEF DESCRIPTION OF THE DRAWINGS

FIG. 1 is a view showing a general structure of an alerting device according to a first embodiment of the present invention.

FIG. 2 is a system diagram of the alerting device according to the first embodiment.

FIG. 3 is a view showing a general structure of the alerting device according to a second embodiment of the present invention.

FIG. 4 is a system diagram of the alerting device according to the second embodiment.

FIG. 5 is a general view showing a third embodiment of the alerting device according to the present invention.

FIG. 6 is a general view showing an embodiment of a sorting device according to the present invention.

FIGS. 7A to 7E are views showing embodiments of the transporting method according to the present invention.

FIG. 8 is a schematic view of a displaying device in accordance with the alerting device of the present invention.

FIG. 9 is a general view showing a fourth embodiment of the alerting device according to the present invention.

FIG. 10 is a general view showing an embodiment of an exposure apparatus according the present invention.

FIG. 11 is a flowchart showing an example of operations in a manufacturing process for semiconductor devices.

### DETAILED DESCRIPTION OF THE INVENTION

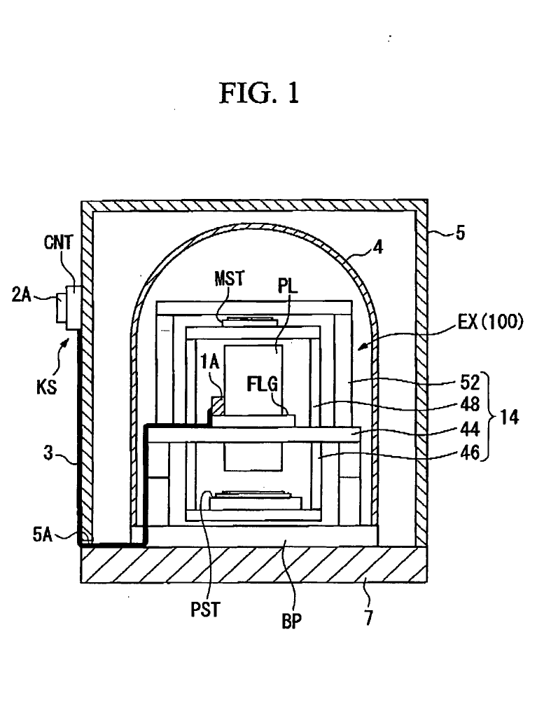

Hereinafter, an alerting device and a transporting device of the present invention are explained with reference to the drawings. FIG. 1 is a general view showing a first embodiment of the alerting device according to the present invention. The alerting device units information relating to at least any one of transportation conditions and transportation environment of the precision apparatus being transported. The present embodiment is explained with reference to an exposure apparatus as an example of the precision apparatus.

In FIG. 1, an alerting device KS, mounted to an exposure apparatus 100 (main body EX of the exposure apparatus) to be transported, has a shock sensor 1A which forms a detecting device which detects shocks acting on the exposure apparatus 100, a controlling device CNT which forms a determining device which determines whether or not values detected by the shock sensor 1A exceed predetermined tolerable values (predetermined values), and an informing device 2A which emits alerts in accordance with determination results by the controlling device CNT.

The precision apparatus, e.g., the exposure apparatus 100 (main body EX of the exposure apparatus) has a mask stage MST which supports a mask, a substrate stage PST which supports photo-lithographic substrates, a projection optical system PL which projects pattern images of the mask supported by the mask stage MST onto the photolithographic substrates supported by the substrate stage PST, and a main body column 14 which supports the mask stage MST, the projection optical system PL, and the substrate stage PST. The main body column 14 has a lens barrel plate 44 which supports a lens barrel of the projection optical system PL via a flange section FLG, a first column 48 and a second column 52 which are disposed on the lens barrel plate 44, and a hanging column 46 which is disposed so as to hang from the lens barrel plate 44. The main body column 14 is supported on a frame caster BP. The frame caster BP is supported on a pedestral 7. The pedestral 7 is formed of, for example, an iron plate.

As explained later, the exposure apparatus 100 is formed by a plurality of units, e.g., a lighting unit including an illumination optical system which emits exposure light to the mask supported on the mask stage MST, a control system unit which includes a control system which integrally controls entire operations of the exposure apparatus 100, a chamber unit which includes a chamber device which contains the exposure apparatus, and a temperature control unit which adjusts temperature in the chamber device. The present embodiment is explained with reference to an example of transportation in which units (hereinafter the main body EX of the exposure apparatus), e.g., the main body of the exposure apparatus which includes the mask stage MST, the substrate stage PST, and the projection optical system PL, are included in the main body EX of the exposure apparatus.

The shock sensor 1A, mounted to the flange section FLG in the projection optical system PL in the present embodiment, detects shocks acting on the main body EX of the exposure apparatus being transported. The shock sensor 1A, which detects information with regard to the shocks acting on the main body EX of the exposure apparatus by detecting information with regard to acceleration of the main body EX of the exposure apparatus being transported, is formed by an acceleration sensor. Also, the shock sensor 1A has a timer function and a memory function (built-in memory section) which enable the shock sensor 1A to store information, e.g., a time when the shock occurred, and length of time during which the shock acted on the main body EX of the exposure apparatus

In the present embodiment, the shock sensor 1A makes sample values which indicate the shocks at a predetermined sampling frequency (for example, 2 msec.) so that a value indicating the greatest shock during every predetermined time interval (for example, two minutes) is stored in the built-in memory section. This structure realizes an electricity-saving-structure by which it is possible to store shock-value-data over a relatively long term transportation operation, e.g., for a week.

The informing device 2A, which emits alerts by emitting light in accordance with determination results determined by the controlling device CNT, is formed by an alerting lamp. The shock sensor 1A and the controlling device CNT are connected by a cable 3.

The main body EX of the exposure apparatus to be transported is packed by: a first packaging material 4, and a second packaging material 5 packs the first packaging material 4 from the outside thereof. The shock sensor 1A which is mounted to the flange section FLG of the projection optical system PL in the main body EX of the exposure apparatus is mounted on an inside of the first packaging material 4. On the other hand, the informing device 2A is mounted on an outside of the first packaging material 4, e.g., more specifically, the outside of the second packaging material 5 which packs the first packaging material 4. In the present embodiment, the informing device 2A is mounted, together with the controlling device CNT, at a predetermined position on an upper section of the outside of the second packaging material 5.

The first packaging material 4 is formed of a material which produces less organic gas than the second packaging material 5. The first packaging material 4 is a sheet material which is formed of: fluorine-containing polymers, e.g., tetrafluoroethylene, tetrafluoroethylene-perfluoro (alkylvinylether), and tetrafluoroethylene-hexaflouoropropene copolymer; or a scaled high-barrier sheet which has a three-layer structure made of nylon (ONY polymerization)-one-side-coated-silica PET resin (PET12)-polyethylene (PEF60). The first packaging material 4 is disposed so as to cover the main body EX of the exposure apparatus so that an end section of the first packaging material 4 is welded to the frame caster BP which supports the main body EX of the exposure apparatus (main body column 14). By doing this, the inside of the first packaging material is sealed. In addition, the sealed space inside of the first packaging material 4 in which the main body EX of the exposure apparatus is disposed is filled with an inert gas, e.g., nitrogen gas. By doing this, contaminating substances, e.g., organic gases, are prevented from adhering to optical elements in the projection optical system through which the exposure light is transmitted. The second packaging material 5, fixed to the pedestral 7, is formed of a lumber material. Also, a cushion material and a thermal insulation material (not shown in the drawings) are disposed between the first packaging material 4 and the second packaging material 5.

The cable 3, disposed between the frame caster BP and the first packaging material 4, which connects the shock sensor 1A disposed inside of the first packaging material 4 and the controlling device CNT disposed outside of the second packaging material 5 transmits signals detected by the shock sensor 1A to the controlling device CNT. The first packaging material 4 is welded to the frame caster BP while sandwiching the cable 3. By doing this, the cable 3, the frame caster BP, and the first packaging material 4 make contact; thus, an inside space in the first packaging material is maintained in a sealed state. Also, a hole section which can support the cable 3 is formed on a predetermined position of the first packaging material 4. After the cable 3 is disposed in this hole section, the hole section may be sealed and the space inside of the first packaging material 4 may be replaced with an inert gas. Also, a through hole 5A, which can support the cable 3, is formed at a predetermined position on the second packaging material 5. The cable 3 extends to the controlling device CNT which is mounted on an outside surface of the second packaging material 5 via the through hole 5A. In addition, the main body EX of the exposure apparatus is transported under the condition that the main body EX of the exposure apparatus is packed by the first and the second packaging materials 4 and 5.

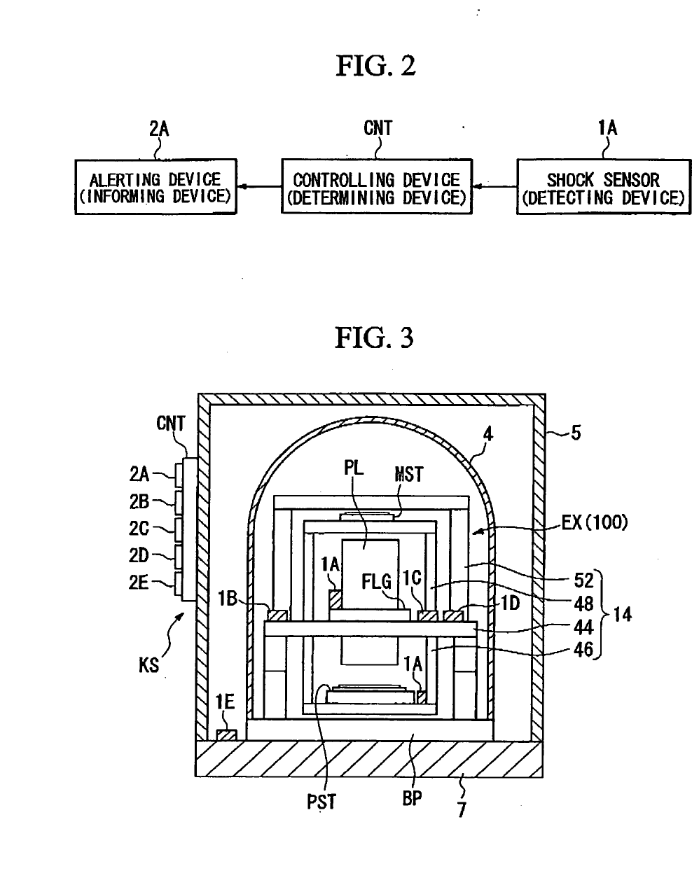

FIG. 2 is a block diagram of a controlling system which includes the shock sensor 1A, the controlling device CNT, and the informing device 2A. The shock sensor 1A detects shocks (accelerations) which act on the main body EX of the exposure apparatus and sends out detected signals to the controlling device CNT via the cable 3. The controlling device CNT determines whether or not the values (acceleration values) detected by the shock sensor 1A exceed the predetermined tolerable values. The tolerable values, e.g., values which have been predetermined by, for example, experiments, indicate values indicating shocks (acceleration values) which do not affect the main body EX of the exposure apparatus. In addition, data indicating the tolerable values are stored in advance in the controlling device CNT (or a storage device connected to the controlling device CNT). The controlling device CNT compares the values detected by the shock sensor 1A with the stud tolerable values, determines whether or not the detected values exceed the tolerable values, and drives the informing device 2A when the controlling device CNT determines that the detected values have exceeded the tolerable values. The informing device 2A, formed by the alerting lamp emits light in accordance with the determination results by the controlling device CNT. More specifically, the informing device 2A emits light when the controlling device CNT determines that the detected values have exceeded the tolerable values. By doing this, alerts indicating that detected values indicating shocks have exceeded the tolerable values are emitted to people therearound, e.g., operators (transporters). The operators who have received the alerts emitted by the alerting device KS (informing device 2A) can handle the situation promptly by, e.g., notifying the transporter who has undertaken the transportation, the party who has ordered the transportation, or the party to whom the main body EX of the exposure apparatus is being transported, of the fact that shock exceeding the tolerable values have acted on the main body EX of the exposure apparatus, of the state of the main body EX of the exposure apparatus, and observing the main body EX of the exposure apparatus and the packing materials. A reset button (resetting structure) is disposed on the informing device 2A. The operator who has noticed the alerts emitted by the informing device 2A can stop the operation of the informing device 2A by pushing the reset button.

As explained above, the shock sensor 1A is mounted to the main body EX of the exposure apparatus, the controlling device CNT determines whether or not the values detected by the shock sensor 1A exceed the predetermined tolerable values, and the informing device 2A, disposed outside of the packaging materials, informs of the determination results. Therefore, the operator is able to perceive the real-time situation with respect to whether or not the shocks exceeding the predetermined values have acted on the main body EX of the exposure apparatus. Therefore, it is possible to handle the situation appropriately and promptly; thus, it is possible to minimize adverse effects on the main body EX of the exposure apparatus.

Also, the shock sensor 1A is mounted to the main body EX of the exposure apparatus. By doing this, values indicating the shocks which have acted on the main body EX of the exposure apparatus can be detected accurately. Also, the informing device 2A is mounted to an outside of the packaging materials. By doing this, the informing device 2A can reliably notify of the alerts to the operators around thereof.

In the present embodiment, the shock sensor 1A is mounted to the flange section FLG in the vicinity of the projection optical system PL. The projection optical system PL is one of the important sections which determines exposure performance in the exposure apparatus 100. If an imaging performance has changed due to shocks, accurate exposure treatment cannot be realized. However, the shock sensor 1A is mounted to or in the vicinity of the projection optical system PL; thus, it is possible to detect the shocks which have acted on the projection optical system PL and apply appropriate remedies. The shock sensor 1A may be mounted, e.g., on the lens barrel of the projection optical system PL, otherwise, in the vicinity (for example, the lens barrel plate 44) of the projection optical system PL in the main body column 14. It is possible for the shock sensor 1A to be mounted in positions other than at the projection optical system PL and the vicinity thereof (for example, in vicinity of the mask stage and the substrate stage). Alternatively, the shock sensor 1A may not be mounted to the main body EX of the exposure apparatus directly. Instead for example, the shock sensor Ia may be mounted to or in the vicinity of the main body EX of the exposure apparatus, e.g., on the pedestral 7.

In the present embodiment, one shock sensor 1A is described. A plurality of shock sensors may be disposed in each of a plurality of positions. Alternatively, a plurality of shock sensors 1A (e.g., two) may be disposed so as to be close to each other. By doing this, even if one of the shock sensors 1A has a problem, it is possible to detect the shocks which have acted on the main body EX of the exposure apparatus with another one of the shock sensors 1A. Also, an average of the values detected by each of the plurality of sensors may be calculated so as to be compared with the tolerable values. Also, a maximum value among the values detected by the plurality of sensors may be compared with the tolerable values. Also, there may be a case in which vibrations (shocks) cannot be detected sensitively because of the position at which the shock sensors 1A are disposed and vibration modes. By mounting the shock sensors 1A at a plurality of positions, it is possible to detect the shocks which act on the main body EX of the exposure apparatus sensitively.

As explained above, the shock sensor 1A has a built-in memory section. Therefore, the shock sensors 1A may be detached from the main body EX of the exposure apparatus after the transportation of the main body EX of the expose apparatus, information with respect to shock values (acceleration information) stored in the memory section may be extracted, and data of the extracted information may be analyzed. The memory section may be disposed in the controlling device CNT which is disposed outside of the packaging material. On the other hand, if the memory section is built in the shock sensor 1A (or in the vicinity thereof), a cable is not necessary to transmit the signals detected by the shock sensor 1A. Therefore, the influence of noise on the data stored in the memory section with respect to the shocks can be reduced.

In the present embodiment, the shock sensor 1A emits the detected values to the controlling device CNT on a real-time basis. In the present embodiment, the shock sensor 1A may be a dual-value-outputting sensor in which a signal indicating “ON” is outputted when a shock which exceeds the tolerable value has acted on the main body EX of the exposure apparatus, and except for that case, no signals are outputted (or a signal indicating “NO” is outputted). This structure can realize an electricity-saving-structure.

In the present embodiment, the first packaging material 4 which packs the main body EX of the exposure apparatus is packed by the second packaging material 5, and the informing device 2A is mounted to an outside surface of the second packaging material 5. In addition, the outside of the second packaging material 5 may be packed by a third packaging material. In this case, the informing device 2A is disposed on an outside surface of the third packaging material. That is, if the main body EX of the exposure apparatus is packed by overlapping a plurality of packaging materials, the informing device 2A is mounted to an outermost surface of the packaging material so that the light emitted from the alerting lamp may be observed from around thereof. On the other hand, the first packaging material 4 may not be packed by the second packaging material 5. In this case, the informing device 2A is mounted to an outside surface of the first packaging material 4. Also, it is not necessary to mount the informing device 2A on an outside surface of the packaging material. The informing device 2A may be mounted at a predetermined position distant from the packaging material, e.g., a position desirable to be observed the operator, by suitably arranging the cable 3.

The informing device 2A may be an alarm device which emits a sound. If the informing device 2A is an alarm device which emits a sound, the sound emitted from the alarm device can reach the outside thereof via the packaging material; therefore, the informing device 2A formed by the alarm device may be mounted to an inside of the packaging material.

The present embodiment has been explained with reference to a precision apparatus, e.g., the exposure apparatus to be transported. The precision apparatus to be transported may be another apparatus forming the semiconductor manufacturing device, e.g., a coating device, a developing device, a CVD device, a CMP device, and other precision apparatuses in addition to the semiconductor manufacturing device, e.g., a precision measurement instrument.

Next, a second embodiment of the alerting device KS according to the present invention is explained with reference to FIG. 3. In the following, the same reference numerals are used for features which are the same as or equivalent to those of the first embodiment; thus, explanations thereof are simplified or omitted.

In FIG. 3, a temperature sensor 1B which detects a temperature of an environment to which the main body EX of the exposure apparatus is exposed, a humidity sensor 1C which detects a humidity thereof, and an oxygen density sensor 1D which detects a density (density of a predetermined substance) of oxygen around the main body EX of the exposure apparatus, are disposed inside of the first packaging material 4 which covers the main body EX of the exposure apparatus. Also, an attitude sensor 1E which detects attitudes of the main body EX of the exposure apparatus, more specifically, a slanting condition thereof, is disposed in a space between the first packaging material 4 and the second packaging material 5 on the pedestral 7. In an example shown in FIG. 3, while the temperature sensor 1B, the humidity sensor 1C, and the oxygen density sensor 1D are disposed in the lens barrel plate 44, the shock sensor 1A is disposed in the vicinity of the flange section FLG of the lens barrel in the projection optical system PL and the substrate stage PST. Here, although the sensors 1B to 1E are disposed so that one of 1B, one of 1C, one of 1D, and one of 1E are disposed respectively, each of the sensors 1B to 1E may be plurally disposed, e.g., a plurality of sensors 1B, a plurality of sensors 1C, a plurality of sensors 1D, and a plurality of sensors 1E. In such a case, the tolerable values which are set for each of the sensors 1B to 1E can be differentiated in accordance with positions in which each of the sensors 1B to 1E are disposed. For example, the tolerable values set for the temperature Sensor 1B and the oxygen density sensor 1E which are disposed in the vicinity of the projection optical system PL may be set more strictly than those set for the other temperature sensor 1B and the other oxygen density sensor 1E. By doing this, it is possible to set the optimal tolerable value in accordance with the disposition of the sensors. Also, each of the sensors 1B to 1E has a built-in memory section similar to the first embodiment.

Also, the controlling device CNT and a plurality of informing devices 2A to 2E are mounted on an outside surface of the second packaging material 5. Each of the informing devices 2A to 2E is disposed so as to correspond to each of the sensors 1A to 1E which are mounted on the main body EX of the exposure apparatus or in vicinity thereof Here, each of the informing devices 2A to 2E is formed of alerting lamps. Also, a resetting structure (reset buttons) is disposed to each of the informing devices 2A to 2E. In addition, in FIG. 3, the cable which connects each sensor and each informing device is omitted.

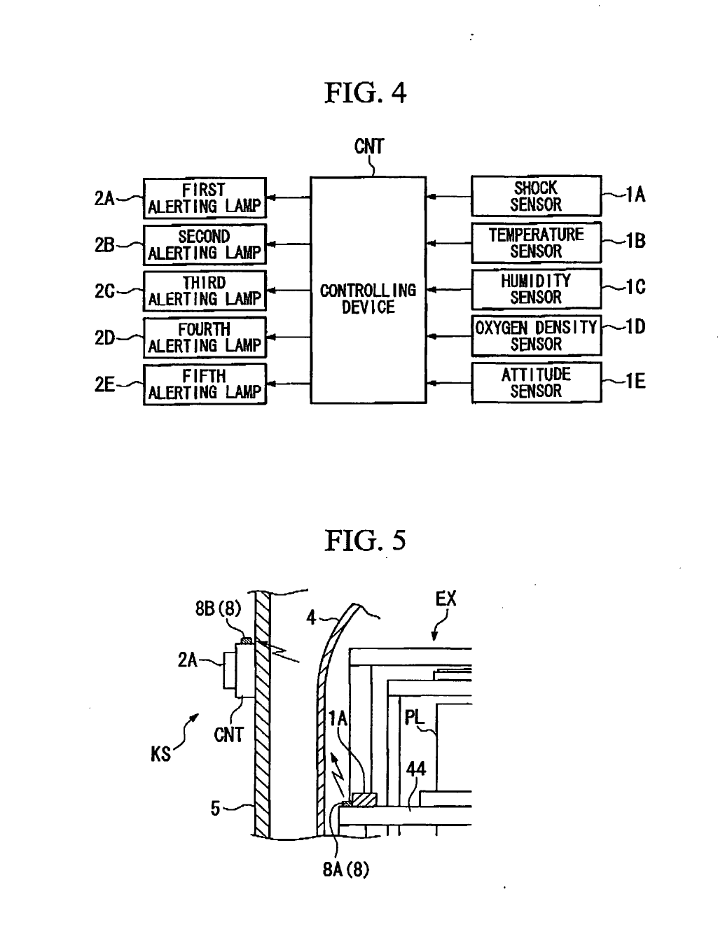

FIG. 4 is a block diagram of a controlling system which includes the controlling device CNT and the informing devices 2A to 2E. The temperature sensor 1B detects the temperature of an environment to which the main body EX of the exposure apparatus is exposed, and emits signals with respect to the detection to the controlling device CNT. The controlling device CNT determines whether or not the values (temperature values) detected by the temperature sensor 1B exceed the predetermined tolerable values. Alternatively, if there are a plurality of temperature sensors 1B in a plurality of positions on, for example, the projection optical system PL, whether or not differences in the values detected by the plurality of the temperature sensors 1B, e.g., temperature gradients have exceeded the predetermined tolerable values, is determined. The tolerable values, e.g., values which have been predetermined by experiments, indicate values indicating temperatures which do not affect the main body EX of the exposure apparatus. In addition, the data with respect to the tolerable values are stored in the controlling device CNT (or a storage device) in advance. The controlling device CNT compares the values detected by the temperature sensor 1B with the stored tolerable values, determines whether or not the detected values exceed the tolerable values, and drives the second alerting lamp 2B when the controlling device CNT determines that the detected values have exceeded the tolerable values. The second alerting lamp 2B emits light in accordance with the determination results by the controlling device CNT. More specifically, the second alerting lamp 2B emits light when the controlling device CNT determines that the detected values have exceeded the tolerable values. By doing this, alerts indicating that detected values indicating temperatures have exceeded tie tolerable values are emitted to people around thereof, e.g., operators (transporters). The operators who have received the alerts emitted by the second alerting lamp 2B can handle the situations by, e.g., notifying the transporter who has undertaken the transportation, the party who has ordered the transportation, or the party to whom the main body EX of the exposure apparatus being transported, of a fact that the main body Ex of the exposure apparatus is being subjected to an abnormal environment, and of the situation with respect to the main body EX of the exposure apparatus, and cooling the environment to which the main body EX of the exposure apparatus is exposed.

Similarly, the controlling device CNT emits alerts by driving a third alerting lamp 2C in accordance with the signal detected by the humidity sensor 1C when humidities are extraordinary around the main body EX of the exposure apparatus being transported. The controlling device CNT emits alerts by driving a fourth alerting lamp 2D in accordance with the signals detected by the oxygen density sensor 1D when the oxygen density is abnormal around the main body EX of the exposure apparatus being transported. The controlling device CNT emits alerts by driving a fifth alerting lamp 2E in accordance with the signals detected by the slant sensor 1E when the main body EX of the exposure apparatus is slanted excessively during transportation.

The oxygen density sensor 1D detects an oxygen density in a space inside the first packaging material 4. That is, if the exposure light used in the exposure apparatus 100 is a vacuum ultra-violet ray, e.g., an F2 laser, oxygen serves as a light-absorbing substance which absorbs the exposure light; thus, the exposure accuracy is affected. Therefore, it is necessary to prevent the oxygen from adhering to optical elements disposed on an optical path of the exposure light. It is possible to observe whether or not oxygen permeates in a space, filled by inert gas (nitrogen gas), inside of the first packaging material 4 by detecting the oxygen density around the main body EX of the exposure apparatus by the oxygen density sensor 1D even during transportation. Here, the density sensor has been explained with reference to the oxygen density sensor for detecting the density of a predetermined substance around the main body EX of the exposure apparatus. Any sensor may be used which can detect gas affecting the exposure accuracy, e.g., organic gas.

FIG. 5 is a view showing a third embodiment of the alerting device KS. In FIG. 5, the alerting device KS has: the shock sensor 1A mounted to the main body EX of the exposure apparatus; the controlling device CNT and the informing device 2A which are mounted to an outside surface of the second packaging material 5; and a wireless communication section 8 which makes wireless communications between the shock sensor 1A and the controlling device CNT. The wireless communication section 8 has a wireless transmitting section 8A which is connected to the shock sensor 1A, and a wireless receiving section 8B which is connected to the controlling device CNT. The signals detected by the shock sensor 1A are transmitted wirelessly by the wireless communication section 8 to the controlling device CNT. The controlling device CNT determines whether or not values detected by the shock sensor 1A and received via the wireless communication section 8 have exceeded the tolerable values. The wireless communication is available in this manner instead of using a cable which connects the shock sensor (detecting device) 1A and the controlling device CNT so as to make a wire-lined communication.

In each of the above embodiments, the controlling device CNT may calculate the accumulated time of receiving shocks even if the values detected by the shock sensor 1A are less than the tolerable values, and whether or not the values indicating the shocks have exceeded the tolerable values may be determined in accordance with information with respect to the accumulated time, and thereby the informing device 2A may inform so. That is, there is a possibility that the main body EX of the exposure apparatus may be affected if shocks, each of which may be less than the tolerable values, have acted on the main body EX of the exposure apparatus. It is possible to prevent adverse effects on the affection to the main body EX of the exposure apparatus in advance by emitting alerts when values with respect to the accumulated time for receiving the shocks have exceeded the predetermined values. Not only information with regard to accumulated shocks but also with regard to accumulated temperature may be reliably calculated; thus, whether or not the temperature has exceeded the predetermined value may be determined in accordance with the accumulated information.

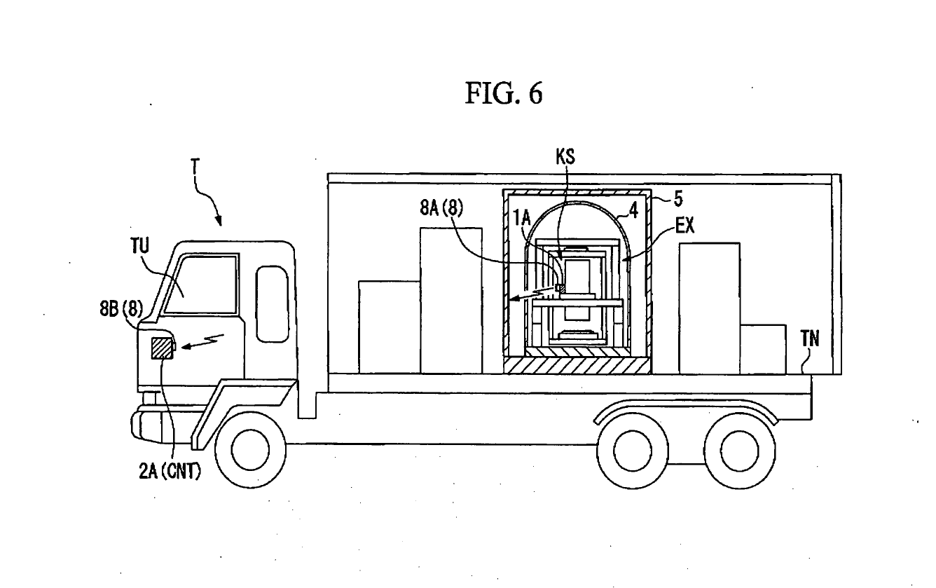

FIG. 6 is a general view showing a cargo vehicle (truck) T which forms a part of the transporting device having the alerting device KS. In FIG. 6, the main body EX of the exposure apparatus, to which the shock sensor 1A forming a part of the alerting device KS is mounted, is carried on a cargo platform TN of the truck T. In addition, a plurality of units, e.g., the above explained illumination system unit, a controlling system unit which includes the controlling system, a chamber unit, and a temperature-controlling unit which adjusts temperature in the chamber device, which form the exposure apparatus 100, are carried on the cargo platform TN. Also, the truck T has a temperature controlling device which adjusts temperature and humidity in a space inside the cargo platform (container) in which the main body EX of the exposure apparatus is disposed.

In addition, the wireless transmitting section 8A, which forms a part of the wireless communication section 8, is connected to the shock sensor 1A. On the other hand, the controlling device CNT to which the wireless receiving section 8B is connected and the informing device 2A, are disposed in a driver's seat TU. This structure enables the driver to notice whether or not shocks exceeding the tolerable values have acted on the main body EX of the exposure apparatus during driving the truck T.

Here, the shock sensor 1A, which is mounted to the main body EX of the exposure apparatus on the cargo platform of the truck T, and the informing device 2A which is mounted to or in the vicinity of the driver's seat TU, may be reliably connected by a cable (wireline). Also, although explanations are made with reference to the shock sensor here, signals detected by the temperature sensor and the humidity sensor may be transmitted to the informing device (controlling device) which is mounted to the driver's seat TU.

In the present embodiment, tolerable values with respect to values indicating shocks are set with respect to each unit which forms the exposure apparatus 100. For example, the tolerable values which are set to the main body EX of the exposure apparatus are low (strict), and the tolerable values which are set to the chamber unit and the controlling system unit am high (lenient). It is possible to set the tolerable values corresponding to the units which form the exposure apparatus 100 in this manner so that the tolerable values are set strictly to elements having the exposure accuracy which depends on the shocks which act thereon, and the tolerable values are set leniently to elements which are relatively resistant to the shocks.

Alternatively, a plurality of function units may be transported by a plurality of trucks respectively. Accordingly, during the transportations of the function units, the tolerable values may be set with respect to the function units (trucks). This structure, which takes transportation speed (transportation operability) into account, enables prompt operations in the transportation because the truck, which transports a relatively shock-resistant function unit, e.g., the chamber unit, has lenient tolerable values.

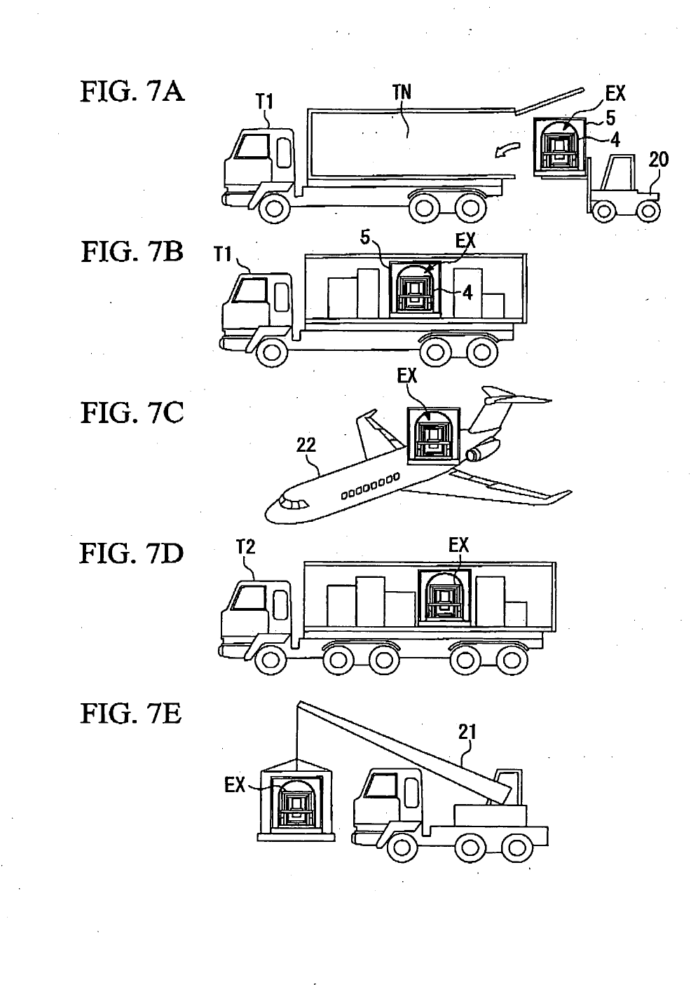

FIGS. 7A to 7E are views explaining the steps of transporting the exposure apparatus from an exposure apparatus manufacturer to a semiconductor device manufacturer. As shown in FIG. 7A, the main body EX of the exposure apparatus which has been manufactured by the exposure apparatus manufacturer is packed by the first and the second packaging materials 4 and 5, and after that, the main body Ex of the exposure apparatus is moved onto the cargo platform (container) TN of the truck T1 by a fork lift 20. Consequently, as shown in FIG. 7B, the main body EX of the exposure apparatus is transported to an airport by the truck T1, and after that, the main body EX of the exposure apparatus is stored in storage (having a roof) for a predetermined period. As shown in FIG. 7C, the main body EX of the exposure apparatus is loaded into an aircraft 22 and transported by air to a destination airport. When the main body EX of the exposure apparatus arrives at the destination airport, the main body EX of the exposure apparatus is stored in a storage (having a roof) at the destination airport. After that, the main body EX of the exposure apparatus is transported to the recipient by semiconductor device manufacturer by a truck prepared at the destination side. Consequently, as shown in FIG. 7E, the main body EX of the exposure apparatus is delivered to a semiconductor device manufacturer's site using a cane 21 and elevators not shown in the drawings.

After the main body EX of the exposure apparatus is delivered to the semiconductor device manufacturer, the shock sensor 1A which has been mounted to the main body EX of the exposure apparatus is detached, and thereby data with respect to values indicating shocks stored in the built-in memory section are extracted.

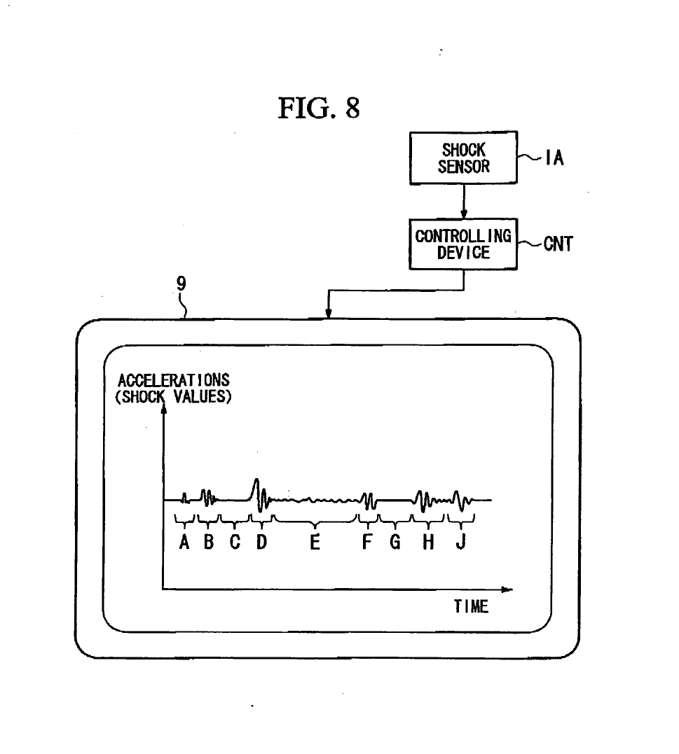

FIG. 8 is a schematic view which shows the data with respect to values indicating shocks stored in the built-in memory section displayed on a displaying device 9. The displaying device 9 is formed of, for example, a liquid crystal display device. Here, as explained above, the shock sensor 1A has a timer function together with the built-in memory section. Data indicating values with respect to shocks, and time as to when the shocks occurred are stored in the built-in memory section; thus, the displaying device 9 can display a graph shown in FIG. 8. In the graph shown in FIG. 8, a horizontal axis indicates time, and a vertical axis indicates values with respect to shocks (accelerations). A period “A” indicates data with respect to shocks which acted on the main body EX of the exposure apparatus when the main body EX of the exposure apparatus was disposed on the truck T1 by the fork lift 20 at the exposure apparatus manufacturer. A period “B” indicates data with respect to shocks during the transportation by the truck T1. A period “C” indicates data with respect to shocks during being stored in the storage. A period “D” indicates data with respect to shocks during transport from storage to the aircraft. A period “E” indicates data with respect to shocks during transport by the aircraft. A period “F” indicates data with respect to shocks during unloading the main body EX of the exposure apparatus from the aircraft at the destination airport. A period “G” indicates data with respect to shocks during storage at the destination airport. A period “H” indicates data with respect to shocks during transport by the truck T2 prepared by the destination side. A period “J” indicates data with respect to shock during handling the main body EX of the exposure apparatus at the semiconductor device manufacturer. The displaying device 9 which displays values detected by the shock sensor 1A forms a part of the alerting device KS; thus, it is possible for data with respect to shocks stored in the built-in memory section in the shock sensor 1A to be displayed on the displaying device 9. Also, the displaying device 9 and the informing device 2 may be disposed together; thus, this structure may enable the displaying device 9 to display values detected during the transportation by the shook sensor 1A on a realtime basis.

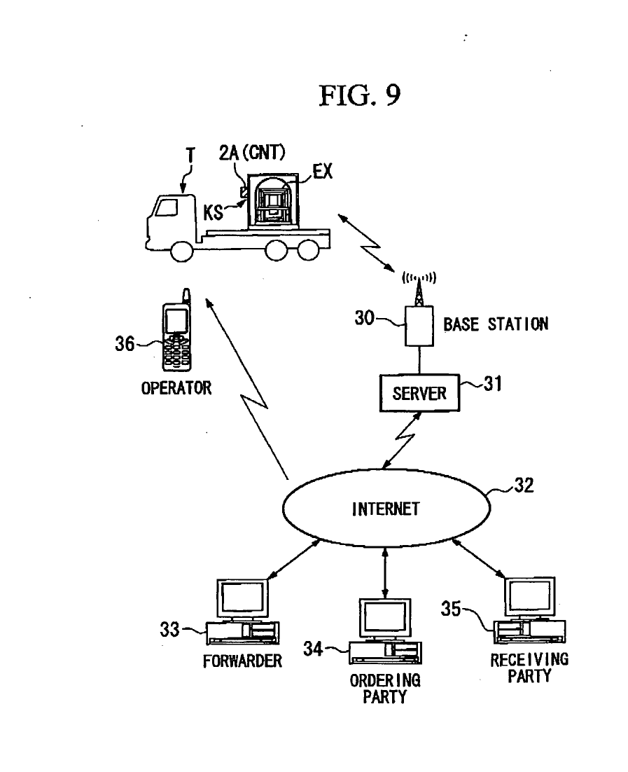

FIG. 9 is a general view showing a fourth embodiment of the alerting device KS according to the present invention. As shown in FIG. 9, when shocks equal to or greater than tolerable values act on the main body EX of the exposure apparatus during the transportation by the truck T, the informing device 2a in the alerting device KS emits alerts to a forwarder 33 who undertakes the transportation, an ordering party 34 who orders the transportation, a receiving party 35 who is a recipient of the main body EX of the exposure apparatus, and operators 36 who transport the main body EX of the exposure apparatus notifying them that the values of the shocks which acted on the main body EX of the exposure apparatus are equal to or greater than the tolerable values via, e.g., a base station 30 of a mobile terminal (mobile telephone) which forms a part of the communication device, a server 31, and Internet 32. Each of the forwarder 33, the ordering party 34, and the receiving party 35 have personal computers which form a part of the communication device. They can be informed of the alerts in accordance with the displayed alerts. Also, the operators 36 have mobile phones; therefore, they can be informed of the alerts in accordance with the alerts displayed on a display section of the mobile phone. This structure enables each of the forwarder 33, the ordering party 34, the receiving party 35, and the operators 36 to be promptly informed that shocks equal to or greater than tolerable values have acted on the main body EX of the exposure apparatus during the transportation. Thus, they can conduct appropriate remedies promptly.

Also, the informing device 2A (controlling device CNT) transmits information with respect to: product information of the main body EX of the exposure apparatus; receiving party's information to whom the main body EX of the exposure apparatus is transported; information with respect to places where the detected values with respect to shocks exceeded the tolerable values; and information with respect to the values which indicate the detected shocks, via the communication device, e.g., Internet 32. The product information includes the product type (exposure apparatus) and serial number of the product. The receiving party's information includes a name, address, and delivery date (e.g., when the deadline for the delivery to the receiving party will be). The information with respect to place can be specified by a GPS (Global Positioning System); thus, the specified information is sent to the forwarder 33, the ordering party 34, the receiving party 35, and the operators 36. Alternatively, the information with respect to place may indicate a range (period), e.g., during the transportation by the truck T1 explained with reference to FIGS. 7A to 7E, during the transportation by the truck T2 prepared at the destination side, and during the transportation by the aircraft 22. Also, the information with respect to values which correspond to the shocks may indicate the values (accelerations) with respect to the detected shocks, and in addition, a plurality of steps, e.g., a high level, a middle level, and a low level, so that the degree to which the detected shocks have exceeded the tolerable values can be indicated. Also, this information can be communicated among the forwarder 33, the ordering party 34, the receiving party 35, and the operators 36.

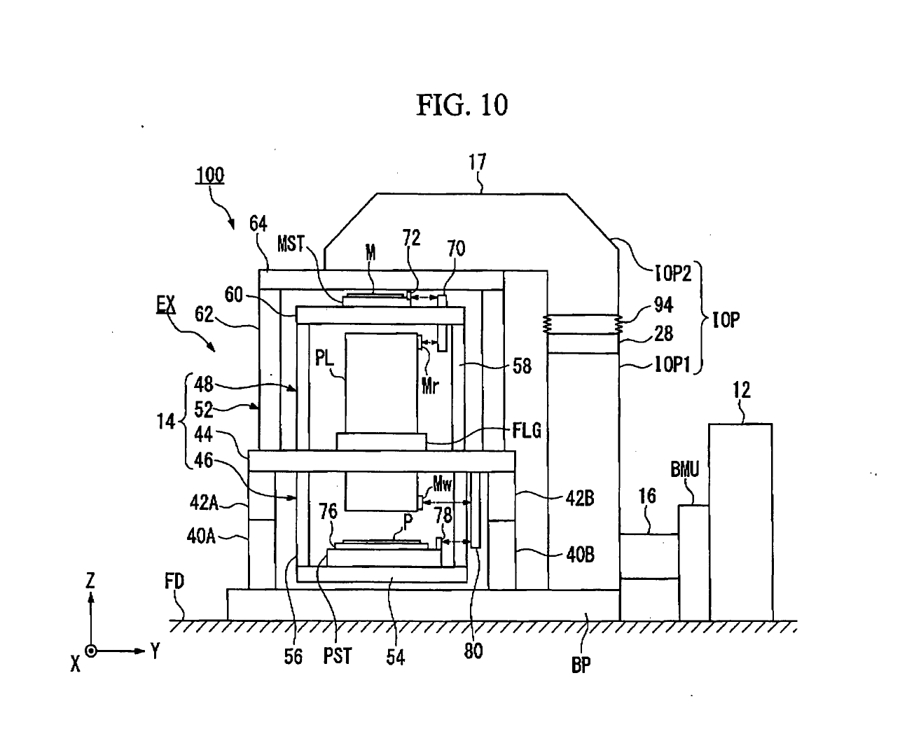

FIG. 10 is a general view of the exposure apparatus 100 which is delivered to the semiconductor device manufacturer and is formed of a plurality of function units which include the main body EX of the exposure apparatus. In FIG. 10, the exposure apparatus 100 has: the mask stage MST which supports a mask M; the substrate stage PST which supports photo-sensitive substrates P; and an illumination optical system IOP which forms the illumination system unit which emits the exposure apparatus to the mask M which is supported by the mask stage MST; and a projection optical system PL which projects the pattern images of the mask M which is lit by the exposure light onto the photo-sensitive substrates P which are supported on the substrate stage PST. Here, the “photo-sensitive substrate” includes substrates on which photo-sensitive materials, e.g., photo-resists, are coated. The “mask” includes reticles which have device patterns which are reduced and projected on the photo-sensitive substrates. Also, the exposure apparatus 100 according to the present embodiment is a scanning exposure apparatus, e.g., a scanning stepper in accordance with a step-and-scan method, in which the mask M and the photo-sensitive substrates P move Synchronously in a one-dimensional direction (hero, in the Y axis direction shown in FIG. 10) so that circuit patterns which are formed in the mask M are transcribed onto each of shot areas on the photo-sensitive substrates P via the projecting optical system PL.

In addition, the exposure apparatus 100 has: a main body column 14 which supports a part of the illumination optical system IOP; the mask stage MST; the projection optical system PL; the substrate stage PST; an anti-vibration unit which restricts or eliminates vibration in the main body column 14; and a controlling system thereof. In the following explanations, an optical axis direction of the projection optical system PL is defined as a Z axis direction. The direction orthogonal to the Z axis direction is defined as a Y axis in which the mask M and the photo-sensitive substrates P move synchronously. A direction in which the mask M and the photo-sensitive substrates P move non-synchronously is defined as an X axis direction. Here, rotational directions around the axes are defined as θZ, θY, and θX respectively.

An ArF excimer laser is used for a light source 12 which outputs a pulse ultraviolet rays having narrow pulses so as to avoid a band which absorbs oxygen in a wavelength range 192 to 194 nm. A main body of the light source 12 is disposed on a floor surface FD in a clean room in the semiconductor device manufacturer's factory. A KrF excimer laser light source which outputs pulse ultra-violet rays which have a wavelength 248 nm or a F2 laser light source which outputs pulse ultra-violet rays which have a wavelength of 157 nm may be used for the light source 12. Also, the light source 12 may be disposed in rooms (e.g. service rooms) which require lower cleanness than clean rooms or in utility spaces which are disposed under the floors of the clean rooms.

Although the light source 12 is omitted in FIG. 10 for the convenience in making the drawings, the light source 12 is connected to an end (an incident end) of a beam matching unit BMU via light-shielding bellows and pipes. Another end (emitting end) of the beam matching unit BMU is connected to a first illumination optical system IOP1 in the illumination optical system IOP via a pipe 16 which has a built-in relay optical system. The relay optical system and a plurality of movable reflecting mirrors are disposed in the beam matching unit BMU. The optical path of the pulse ultra-violet rays (ArF excimer laser beam) which have a narrow pulse and are incident from the light source 12 is matched with the first illumination optical system IOP1 with respect to positions by using the movable reflecting mirrors, etc.

The illumination optical system IOP is formed of two parts, e.g., the first illumination optical system IOP1 and a second illumination optical system IOP2. The first illumination optical system IOP1 is disposed on the base plate (frame caster) BP which serves as a reference point for the device which is horizontally mounted on a floor surface FD. Also, the second illumination optical system IOP2 is supported by a second supporting column 52 which forms the main body column 14 from beneath thereof.

The first illumination optical system IOP1 has a mirror which is disposed in accordance with a predetermined positioning relationship, a movable beam attenuator, a beam-forming optical system, an optical integrator, a light-condensing optical system, a vibrating mirror, a illumination system diaphragm plate, a beam splitter, a relay lens system, and a movable reticle blind 28 which serves as a movable perspective diaphragm which forms a reticle blind structure, etc. When the pulse ultra-violet rays emitted from the light source 12 are incident into the first illumination optical system IOP1 via the beam matching unit BMU and the relay optical system, the pulse ultra-violet rays are adjusted to have a predetermined peak intensity by ND filters in the movable optical attenuator. After that, a cross sectional shape of the pulse ultra-violet rays is adjusted so as to be incident into an optical integrator efficiently by a beam-rectifying optical system. Subsequently, when the pulse ultra-violet ray is incident into the optical integrator, a surface light source, e.g., a second generation light source which is formed by a plurality of light source images (point light source) is formed on an emitting side thereof. After the pulse ultra-violet rays which are dispersed from each of the plurality of point light sources are transmitted through any one aperture diaphragm on the illumination system aperture diaphragm, the pulse ultra-violet rays reach the movable reticle blind 28 and serve as the exposure light.

The second illumination optical system IOP2 has: a fixed reticle blind; a lens; a mirror, the relay lens system; and a main condenser lens, etc. which are contained in a illumination system housing 17 in accordance with a predetermined disposition relationship. The fixed reticle blind, disposed on a plane which is slightly defocused from a conjugate plane with respect to a pattern plane of the mask M in vicinity of the incident end of the illumination system housing 17, has a rectangular aperture section which defines a lighting area on the mask M.

If the first illumination optical system IOP1 and the second illumination optical system IOP2 are cemented rigidly, and when the movable reticle blind 28 is driven, vibrations are generated by the movable reticle blind 28 in the first illumination optical system IOP1 during the exposure operation. Therefore, this is not desirable because the vibrations are transmitted to the second illumination optical system IOP2 which is supported by a second column 52. Accordingly, in the present embodiment, an extendable bellow member 94, which has a sealed space from outside thereof and enables relative displacement of both of the optical systems, connects the first illumination optical system IOP1 and the second illumination optical system IOP2.

The main body column 14 has: a plurality of supporting members 40A to 40D (four members are used in this embodiment, and two members of them, e.g., 40C and 40D are not shown in the drawing) disposed on the base plate BP; the lens barrel plate 44 which is supported substantially horizontally via anti-vibration units 42A to 42D (two members, e.g. 42C and 42D are not shown in the drawing) which are fixed on the supporting members 40A to 40D; a hanging column 46 which is disposed so as to hang from a bottom surface of the lens barrel plate 44; and first and second supporting columns 48 and 52 which are disposed on the lens barrel plate 44.

The lens barrel plate 44 is made of cast iron, etc. An aperture which has a circular shape with respect to a plan view thereof is formed in a center section of the lens barrel plate 44. The projection optical system PL of which the optical axis direction is in the Z axis is inserted through the aperture. The flange FLG which is formed with the lens barrel section unitarily is disposed on an outer periphery section of the lens barrel section of the projection optical system PL. A thermally-low-expanding material, e.g., Inver which is a thermally-low-expanding alloy having 36% Nickel, 0.25% Manganese, and a slight amount of carbon and other elements, is used for the material of the flange FLG. The flange FLG forms a kinematic-supporting mount in which the projection optical system PL is supported at three points, e.g., a point, a surface, and a V-groove, with respect to the lens barrel plate 44.

The hanging column 46 has: a substrate base plate 54; and four hanging members 56 which support the substrate base plate 54 hanging from the banging members approximately horizontally. Also, the first supporting column 48 has: four legs 58 (legs disposed at the far side to viewers of the drawing are omitted in the drawing) which are disposed on the lens barrel plate 44 and surround the projection optical system PL; and a mask base plate 60 which is supported approximately horizontally by the four legs 58. Similarly, the second supporting column 52 is formed by four columns 62 (columns disposed at the far side to viewers of the drawing are omitted in the drawing) which are disposed on an upper surface of the lens barrel plate 44 so as to surround the first supporting column 48, and a top plate 64 which is supported by these four columns 62 approximately horizontally. The above explained second illumination optical system IOP2 is supported by the top plate 64 which is supported on the second supporting column 52.

The mask stage MST is disposed on a mask base plate 60 which forms the first supporting column 48 which forms the main body column 14. The mask stage MST is configured so that: the mask stage MST is driven by a mask stage driving system which is formed by, e.g., a magnetic-levitation-type two-dimensional linear actuator; linear driving of the mask M is conducted on the mask base plate 60 in a Y axis direction with a large stroke; and a micro-driving with respect to X axis direction and θz direction is possible.

A moving mirror which reflects a length-measuring beam which is emitted from a mask laser interferometer 70, which serves as a position detecting device for measuring positions and movement amounts of the mask stage MST, is mounted to a part of the mask stage MST. The mask laser interferometer 70 is fixed on the mask base plate 60 so as to detect positions (including θz rotation) in an XY plane of the mask stage MST (that is, mask M) with reference to a fixed mirror Mr which is fixed on a side plane of an upper end section of the projection optical system PL.

Information with respect to the position (or information with respect to velocity) of the mask stage MST which is measured by the mask laser interferometer 70 is sent to a main controlling device. The main controlling device controls the mask stage driving system so that the information with respect to the position (or information with respect to the velocity) which is output from the mask laser interferometer 70 coincides with command values (e.g., target position target velocities) (more specifically, the information with respect to positions follows the substrate stage PST).

Refractive optical systems are used for the projection optical system so that: only refractive optical elements (lens elements) using a lens material, e.g., quartz and Fluorite are used in the refractive optical system; the refractive optical system has circular tele-centric projection perspectives on an object-plane-side (mask M) and an image-plane-side (photo-sensitive substrate P); and a reduction rate of the refractive optical system is ¼, ⅕, or ⅙. Therefore, if pulse ultra violet rays are emitted onto the mask M, a focusing light bundle which is reflected from a part of a circuit pattern area on the mask M is incident into the projection optical system PL. An inverted image of the circuit pattern area is limited to be in a slit manner or a rectangular (polygonal) manner in a center of the circular perspective on the image plane side of the projection optical system PL, every time each pulse of the pulse ultra violet rays emitted; thus, the pulse ultra violet rays are focused. This enables transcription of a part of the inverted image of the projected circuit pattern in reduced size on a resist layer on a surface of a plurality of shot areas on the photo sensitive substrate P which is disposed on a focusing plane in the projection optical system PL.

The substrate stage PST is disposed on the substrate base plate 54 which forms the above explained hanging column 46 so that the substrate stage PST is driven desirably in the XY plane by a substrate stage driving system which is formed by, e.g., a magnetic-levitation-type two-dimensional linear actuator.

The photo-sensitive substrate P is fixed on an upper surface of the substrate stage PST via a substrate holder 76 using vacuum absorption, etc. Positions and rotation amounts (yawing amount, rolling amount, and pitching amount) are measured in predetermined resolutions on a real-time basis by a substrate laser interferometer 80 which measures changes in positions of the movable minor 78 which is fixed on a part of the substrate stage PST with reference to a reference minor Mw which is fixed on a lower end of the lens barrel in the projection optical system PST. The values measured by the substrate laser interferometer 80 are supplied to the main controlling device. The main controlling device controls the substrate stage driving system in accordance with the measurement results by the substrate laser interferometer 80.

In addition, when the above explained exposure apparatus 100 is transported, the exposure apparatus 100 is divided into; the main body EX of the exposure apparatus; the illumination system unit, e.g., the first illumination optical system IOP1 and the second illumination optical system IOP2; blind unit, e.g., the beam matching unit BMU; the movable reticle blind 28 and the fixed reticle; the controlling system unit, e.g., an amplifier rack; the light source unit, e.g., the laser light source 12; the chamber unit, e.g., the chamber device; the temperature controlling unit, e.g., a temperature controlling rack; a loader system unit; and an appurtenance unit which includes other appurtenances. In addition, the tolerable values with respect to shocks and temperature are set for each of the units as explained above during the transportation of the above units; thus, the units are transported.

Not only semiconductor wafers to manufacture semiconductor devices, but also glass substrates used in display devices, ceramic wafers used in thin film magnetic heads, or a master piece (e.g., synthesized quartz, silicon wafer) of masks or reticles used in exposure apparatuses, etc. are used for the photosensitive substrate P in the above explained embodiments.

The exposure apparatus 100 may be not only a scanning exposure apparatus (scanning stepper) which uses a step-and-scan method in which the pattern of the mask M is scanned and exposed by moving the mask M and the photo-sensitive substrate P synchronously, but also a projection exposure apparatus (stepper) which uses a step-and-repeat method in which the pattern of the mask M is exposed in one exposure session of exposing while immobilizing the mask M and the photo-sensitive substrate P, and the photo-sensitive substrate P is moved in a step manner. Also, the present invention can be applied to an exposure apparatus which uses a step-and-stitch method in which at least two partially-overlapping patterns are transcribed onto the substrate P.

With respect to types of the exposure apparatus 100, the devices are not limited to exposure apparatuses used to manufacture semiconductor elements by exposing patterns of semiconductor elements onto substrates P. A wide variety of exposure apparatuses may be used for the exposure apparatus 100, e.g., liquid crystal display elements, displays, thin film magnetic heads, image-capturing elements (CCD), reticles, or masks.

Linear motors, in accordance with any one of types, (see U.S. Pat. No. 5,623,853 or U.S. Pat. No. 5,528,118), e.g., an air-floating linear motor which uses air-bearings, and a magnetic-levitation-type linear motor which uses Lorentz force or reactance force, can be used for the substrate stage PST and the mask stage MST. Also, stages PST and MST, in accordance with any one of types, e.g., moving along guides, and moving without guides, can be used.

Plane motors can be used for the driving structure which drives each stage PST and MST so that each of the stages PST and MST is driven by electromagnetic force generated by a structure in the plane motor including: a magnet unit in which magnets are disposed in a two-dimensional manner and an armature unit in which coils are disposed in a two-dimensional manner; and the magnet unit and the armature unit face each other. In such a case, one of the magnet unit and the armature unit may be connected to the stages PST and MST, and the other one of the units may be disposed on a moving-side of the stages PST and MST.

A reaction force generated by the movement of the substrate stage PST may be released to a floor (ground) mechanically, e.g., using frame members so that the reaction force does not reach the projection optical system PL as disclosed in Japanese Unexamined Patent Application, First Publication No. H08-166475 (counterpart U.S. Pat. No. 5,528,118).

A reaction force generated by the movement of the mask stage MST may be released to a floor (ground) mechanically, e.g., using frame members so that the reaction force does not reach the projection optical system PL as disclosed in Japanese Unexamined Patent Application, First Publication No. H08-330224 (counterpart U.S. application Ser. No. 08/416,558)

Sections, at which the exposure apparatus is divided into units during the transportation may be determined desirably in accordance with structure of each of the function units in the exposure apparatus, size of appliance used in the transportation, and paths for handling thereof. Sensors may be disposed so that properties necessary to the sensors are set corresponding to features in each of the divided function units. Also, tolerable values necessary for the function units may be set in the controlling device CNT.

As explained above, the exposure apparats 100 according to the present invention is manufactured by assembling sub-systems which include each of the elements recited in Claims of the present application so that the exposure apparatus 100 maintains predetermined accuracies, e.g., mechanical accuracy, electric accuracy, and optical accuracy. In order to achieve these accuracies, before the assembly, the optical accuracy is adjusted in each of the optical systems, the mechanical accuracy is adjusted in each of mechanical systems, and the electric accuracy is adjusted in each of electric systems. Steps in which the sub-systems are assembled to manufacture the exposure apparatus include mutual connections, e.g., mechanical connection among the sub-systems, electric connection of wirings and electric cats, and pipe connection of air pressure circuits Each of the sub-systems must reliably be assembled before the assembly of the sub-systems to manufacture the exposure apparatus. After completing assembly of the sub-systems to manufacture the exposure apparatus, comprehensive adjustment is conducted; thus, the ales are obtained for the entire exposure apparatus. It is desirable that the exposure apparatus is manufactured in a clean room in which temperature and cleanness are controlled.

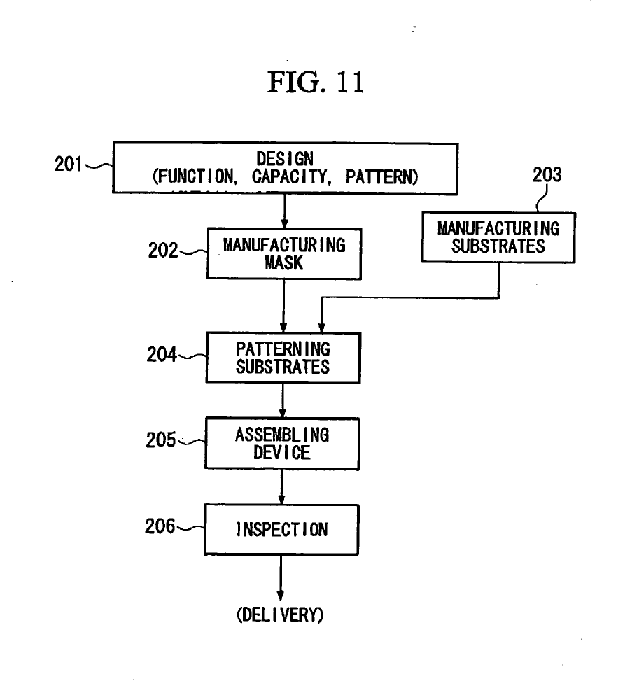

Micro devices, e.g., semiconductor devices, are manufactured in steps shown in FIG. 11: a step 201 in which functions and capacities of the micro devices are designed; a step 202 in which masks (reticles) are manufactured in accordance with the designing step, a step 203 in which base material of the devices, e.g., substrates, are manufactured; a step 204 in which patterns of the masks are exposed onto the substrates by the exposure apparatus EX according to the above explained embodiments, a step 205 including a dicing step, a bonding step, and a packaging step, through which the devices are assembled; and a step 206 for inspecting.

According to the present invention, even if shocks having levels exceeding the predetermined values act on the precision apparatus, it is possible to conduct appropriate remedies promptly; thus, it is possible to transport the precision apparatuses while minimize affections to the precision apparatuses.

What is claimed is:

1. An alerting device comprising:
a detecting device, mounted to or in a vicinity of a precision apparatus being transported, which detects at least any one of transportation conditions and transportation environment;
a determining device which determines whether or not values detected by the detecting device exceed predetermined values; and
an informing device which emits alerts based on the determination results made by the determining device.

2. An alerting device according to claim 1, wherein the detecting device comprises shock sensors which detect shocks applied on the precision apparatus being transported.

3. An alerting device according to claim 1, wherein the detecting device comprises at least any one of temperature sensors and humidity sensors.

4. An alerting device according to claim 1, wherein the detecting device comprises density sensors which detect densities of predetermined substances around the precision apparatus.

5. An alerting device according to claim 1, wherein the detecting device comprises attitude sensors which detect attitudes of the precision apparatus being transported.

6. An alerting device according to claim 1, wherein the detecting device is mounted to an inside of a first packaging material which packs the precision apparatus, and the informing device is mounted to an outside of the first packaging material.

7. An alerting device according to claim 6, wherein the informing device is mounted to an outside of a second packaging material which packs the first packaging material.

8. An alerting device according to claim 1, wherein the informing device emits at least any one of light and sound.

9. An alerting device according to claim 1, fewer comprising a displaying device which displays values detected by the detecting device.

10. An alerting device according to claim 1, further comprising a wireless communicating section which makes wireless communications between the detecting device and the determining device.

11. An alerting device according to claim 1, wherein the informing device emits the alerts, via a communication device, to at least any one of a transporter who transports the precision apparatus, a forwarder who undertakes the transportation, an ordering party who orders the transportation, and a receiving party to whom the precision apparatus is transported.

12. An alerting device according to claim 11, wherein the informing device emits, via the communication device, at least any one of information: information with respect to the precision apparatus; information with respect to the receiving party to whom the precision apparatus is transported; information with respect to places where the detected values exceed the predetermined values; and information with respect to the detected values.

13. An alerting device according claim 1, wherein the precision apparatuses include semiconductor manufacturing apparatus.

14. An alerting device according to claim 13, wherein the semiconductor manufacturing apparatus include exposure apparatuses.

15. A transporting device for transporting precision apparatuses, comprising the alerting device of claim 1.

16. A method of transporting precision apparatuses, comprising transporting the precision apparatuses using the alerting device of claim 1.

17. A transporting method according to claim 16, wherein the predetermined values are set corresponding to each unit which comprises the precision apparatus.

18. An exposure apparatus transported by the method according to claim 16.

19. An exposure apparatus transported by the method according to claim 17.
